(19) United States
(12) Patent Application Publication
(10) Pub. No.: US 2025/0392071 A1
(43) Pub. Date: Dec. 25, 2025

(54) HEAT PASS CONNECTOR

(71) Applicant: KEL CORPORATION, Tokyo (JP)

(72) Inventors: Yoshihiro ABE, Tama-shi (JP); Kotaro ONDA, Tama-shi (JP)

(73) Assignee: KEL CORPORATION, Tokyo (JP)

(21) Appl. No.: 18/975,662

(22) Filed: Dec. 10, 2024

(30) Foreign Application Priority Data
Jun. 20, 2024 (JP) 2024-099797

(51) Int. Cl. H01R 13/502; H01R 12/71

(52) U.S. Cl. CPC H01R 13/502; H01R 12/716

(57) ABSTRACT

To provide a heat pass connector having a heat dissipation function. Connectors 2a and 2b that are used by being attached to substrates B1 and B2 and are fittable into counterpart connectors respectively include contacts C, housings D that hold the contacts C, and shells 40 and 90 each formed of a highly conductive material and surrounding and attached to the housings D, the shells 40 and 90 respectively include mount sections M for bonding the connectors 2a and 2b to substrates B1 and B2 and heat dissipation sections K each having a heat dissipation function, the substrates B1 and B2 respectively include shell bonding sections S for bonding the mount sections M, heat from the heat generation section H on the substrate B1 or B2 being transferred to the shell bonding sections S, and the heat transferred to the shell bonding sections S is dissipatable by being transferred from the mount sections M to the heat dissipation sections K when the shells 40 and 90 are attached to the substrates B1 and B2 by bonding the mount sections M to the shell bonding sections S.

### TECHNICAL FIELD

The present invention relates to a heat pass connector used for electrical connection.

### TECHNICAL BACKGROUND

Electronic devices have been advanced and miniaturized, and heat generated from electronic components and the like provided on printed circuit boards inside the electronic devices has become a problem.

As electrical connectors used for connection on such printed circuit boards, a connector as disclosed in Japanese Laid-Open Patent Publication No. 2020-202042, in which part of the connector is provided with a hole for heat dissipation, has conventionally been known. The connector disclosed in Japanese Laid-Open Patent Publication No. 2020-202042 has a fixed housing and a movable housing that are fixed on a substrate, in which a housing space where the movable housing houses a terminal includes a heat dissipation section that dissipates heat in the housing space to an outer space.

### SUMMARY OF THE INVENTION

However, a connector having such a configuration is used for dissipating heat transferred to the connector and cannot be said to be effective in conducting heat on a substrate to the connector and dissipating the heat. In order to efficiently dissipate heat under limited volume conditions, a new configuration in which heat from a heat source is conducted to a portion having a heat dissipation function and is dissipated is required.

The present invention had been made in view of such a problem, and has as its object to provide a connector having a function of conducting heat on a substrate and dissipating the heat.

To attain the above-described object, a heat pass connector according to a first aspect of the present invention is a connector that is used by being attached to a substrate and is fittable into a counterpart connector, the connector including a contact, a housing that holds the contact, and a heat pass shell formed of a highly conductive material and surrounding and attached to the housing, in which the heat pass shell includes a mount section for bonding the connector to the substrate and a heat dissipation section having a heat dissipation function, the substrate includes a shell bonding section for bonding the mount section, heat from the heat generation section on the substrate being transferred to the shell bonding section, and the heat transferred to the shell bonding section is dissipatable by being transferred from the mount section to the heat dissipation section when the heat pass shell is attached to the substrate by bonding the mount section to the shell bonding section.

In the heat pass connector according to the first aspect of the present invention, it is preferable that the heat dissipation section has an uneven portion formed by subjecting a surface of the heat pass shell to plating treatment and is configured such that a surface area of the heat pass shell increases.

In the heat pass connector according to the first aspect of the present invention, it is preferable that the heat pass shell has a smooth portion having a smooth surface in a fitting section to be fitted into the counterpart connector and is configured such that a contact area between the heat pass shell and a counterpart shell in the counterpart connector increases.

In the heat pass connector according to the first aspect of the present invention, it is preferable that the substrate includes a heat transfer path for transferring the heat from the heat generation section to the shell bonding section and the heat transfer path is formed by a conductive wiring pattern.

In the heat pass connector according to the first aspect of the present invention, it is preferable that the mount section includes a conductive foot section that is elastically deformable while remaining bonded to the shell bonding section.

In the heat pass connector according to the first aspect of the present invention, it is preferable that the foot section has a shape that bends in an L shape outward from the heat pass shell.

To attain the above-described object, a heat pass connector according to a second aspect of the present invention is a connector that is used by being attached to a substrate and is fittable into a counterpart connector, the connector including a heat dissipation plate formed of a highly conductive material, at least one contact that is arranged outside the heat dissipation plate on the substrate when attached to the substrate, and a housing that holds the contact and the heat dissipation plate, in which the heat dissipation plate includes a mount section for bonding to the substrate and a heat dissipation section having a heat dissipation function, the substrate includes a heat dissipation plate bonding section for bonding the mount section, heat from a heat generation section on the substrate being transferred to the heat dissipation plate bonding section, and the heat transferred to the heat dissipation plate bonding section is dissipatable by being transferred from the mount section to the heat dissipation section when the heat dissipation plate is attached to the substrate by bonding the mount section to the heat dissipation plate bonding section.

The heat pass connector according to the second aspect of the preset invention, it is preferable that the heat dissipation section has an uneven portion formed by subjecting a surface of the heat dissipation plate to plating treatment and is configured such that a surface area of the heat dissipation plate increases.

The heat pass connector according to the second aspect of the present invention, it is preferable that the heat dissipation plate has a smooth portion having a smooth surface in a fitting section to be fitted into the counterpart connector and is configured such that a contact area between the heat dissipation plate and a counterpart heat dissipation plate in the counterpart connector increases.

In the heat pass connector according to the second aspect of the present invention, it is preferable that the substrate includes a heat transfer path for transferring the heat from the heat generation section to the heat dissipation plate bonding section and the heat transfer path is formed by a conductive wiring pattern.

In the heat pass connector according to the first or second aspect of the present invention, it is preferable that the contact has a heat dissipation function on its surface.

In the heat pass connector according to the first or second aspect of the present invention, it is preferable that the contact has an uneven portion formed by subjecting the surface to plating treatment and is configured such that a surface area of the contact increases.

In the heat pass connector according to the first or second aspect of the present invention, it is preferable that the substrate includes a heat transfer path for transferring, when each of some of the contacts is attached to the substrate, the heat from the heat generation section to a bonding section between the substrate and the contact and the heat transfer path is formed by a conductive wiring pattern.

To attain the above-described object, a heat pass connector according to a third aspect of the present invention is a connector that is used by being attached to a substrate and is fittable into a counterpart connector, the connector including a plurality of contacts, and a housing that holds each of the plurality of contacts, in which the contact has a heat dissipation function on its surface, and heat transferred to the contact from the substrate is dissipatable by the heat dissipation function.

In the heat pass connector according to the third aspect of the preset invention, it is preferable that the contact has an uneven portion formed by subjecting the surface to plating treatment and is configured such that a surface area of the contact increases.

With the heat pass connector according to the first aspect of the present invention, it is possible to transfer heat from the heat generation section on the substrate to the shell bonding section, conduct the heat to the heat pass shell through the mount section formed of a highly conductive material, and dissipate the heat from the heat dissipation section. It is also possible to conduct heat from the connector provided on the substrate including the heat generation section to the counterpart connector into which the connector is fitted and dissipate the heat from a heat dissipation section included in the counterpart shell in the counterpart connector.

In the heat pass connector having the above-described configuration, the heat dissipation section has the uneven portion formed by plating treatment, so that a surface area of the heat dissipation section can be increased, thereby making it possible to enhance an effect of heat dissipation.

Further, in the heat pass connector having the above-described configuration, the fitting section to be fitted into the counterpart connector has the smooth portion, so that the contact area with the counterpart shell in the counterpart connector increases, thereby making it possible to enhance thermal conductivity in the fitting section. Accordingly, an amount of heat dissipation in the counterpart connector can be increased, thereby making it possible to further enhance an effect of heat dissipation as the entire connector.

Further, in the heat pass connector having the above-described configuration, the heat transfer path for transferring heat from the heat generation section to the shell bonding section is formed as the wiring pattern on the substrate, thereby enabling thermal conduction to the heat dissipation section having a high heat dissipation effect, making it possible to further enhance an effect of heat dissipation.

Further, in the heat pass connector having the above-described configuration, the mount section has the conductive foot section that is elastically deformable while remaining bonded to the shell bonding section. Accordingly, for a connector having a portion that is movable relative to a bonding portion between the connector and a substrate with the connector bonded to the substrate, e.g., a floating connector, the heat pass connector can be applied because it can make the foot section follow relative movement by the elastic deformation with the mount section bonded.

Further, in the heat pass connector having the above-described configuration, the foot section can be more easily elastically deformed by having a shape that bends in an L shape outward from the heat pass shell.

With the heat pass connector according to the second aspect of the present invention, it is possible to transfer heat from the heat generation section on the substrate to the heat dissipation plate bonding section in the heat dissipation plate arranged inside the at least one contact, conduct the heat to the heat dissipation plate through the mount section formed of a highly conductive material, and dissipate the heat from the heat dissipation section. It is also possible to conduct heat from the connector provided on the substrate including the heat generation section to the counterpart connector into which the connector is fitted and dissipate the heat from the heat dissipation section included in the counterpart heat dissipation plate in the counterpart connector.

In the heat pass connector having the above-described configuration, the heat dissipation plate has the uneven portion formed by plating treatment, so that a surface area of the heat dissipation section can be increased, thereby making it possible to enhance an effect of heat dissipation.

Further, in the heat pass connector having the above-described configuration, the fitting section to be fitted into the counterpart heat dissipation plate in the counterpart connector has the smooth portion, so that the contact area with the counterpart heat dissipation plate in the counterpart connector increases, thereby making it possible to enhance thermal conductivity in the fitting section. Accordingly, an amount of heat dissipation in the counterpart connector can be increased, thereby making it possible to further enhance an effect of heat dissipation as the entire connector.

Further, in the heat pass connector having the above-described configuration, the heat transfer path for transferring heat from the heat generation section to the heat dissipation plate bonding section is formed as the wiring pattern on the substrate, thereby enabling thermal conduction to the heat generation section in the heat dissipation plate, making it possible to further enhance an effect of heat dissipation. In the case, the contact is arranged outside the heat dissipation plate, thereby making it possible to ensure a region of the wiring pattern to the contact while ensuring the heat transfer path to the heat dissipation plate bonding section on the substrate.

Further, in the heat pass connector having the above-described configuration, the contact has the heat dissipation function on the surface, thereby making it possible to also dissipate heat transferred to the contact from the substrate from the heat dissipation section in the contact in addition to dissipating heat in the heat dissipation section included in the heat pass shell or the counterpart shell, or the heat dissipation plate or the counterpart heat dissipation plate. This makes it possible to obtain an effect of heat dissipation by the contact even if the connector is small and the heat pass shell or the counterpart shell itself is inevitably small in size. When the above-described shell is used, for example, the shell bonding section and the heat transfer path as a connection portion between the shell and the substrate need to be provided outside a connection portion between the contact and the substrate. Even when the respective surface areas of the heat dissipation section and the mount section in the shell cannot be sufficiently ensured, for example, when there occurs a constraint that a wiring pattern needs to be provided on the substrate while avoiding the shell bonding section and the heat transfer path to form the wiring pattern connected to the contact, part of heat generated in the vicinity of the connector can be dissipated from the contact.

Further, in the heat pass connector having the above-described configuration, the contact has the uneven portion by subjecting the surface of the contact to plating treatment, so that the surface area of the contact can be increased, thereby making it possible to enhance an effect of heat dissipation at the contact.

Further, in the heat pass connector having the above-described configuration, the substrate includes the heat transfer path that transfers heat from the substrate to some of the contacts, and the contact is dedicated for heat dissipation, thereby making it possible to efficiently dissipate heat from the contact.

With the heat pass connector according to the present invention, the connector includes the plurality of contacts and the housing that holds each of the contacts, and the contact has the heat dissipation function on the surface thereof. This makes it possible to dissipate from the contact heat transferred from the substrate to the connector, and making it possible to conduct heat transferred to the contact to the counterpart connector into which the connector is fitted and dissipate the heat from the contact in the counterpart connector.

Further, in the heat pass connector having the above-described configuration, the contact has the uneven portion by subjecting the surface of the contact to plating treatment, so that the surface area of the contact can be increased, thereby making it possible to enhance an effect of heat dissipation at the contact.

### BRIEF DESCRIPTION OF THE DRAWINGS

FIG. 1 is a schematic view illustrating a mechanism of a heat pass connector according to the present invention;

FIG. 2 is a partially enlarged schematic view illustrating the mechanism of the heat pass connector according to the present invention;

FIG. 3 is a perspective view in a fitting state of a connector device including a heat pass connector according to one embodiment of the present invention;

FIG. 4 is a cross-sectional view taken along an arrow V-V in FIG. 3;

FIG. 5 is a perspective view of a plug connector in the connector device;

FIG. 6 is a bottom view of the plug connector;

FIG. 7 is a cross-sectional view taken along an arrow VI-VI in FIG. 5;

FIGS. 8A and 8B are perspective views respectively illustrating a plug-side shell and a left surface out of separated left and right surfaces;

FIGS. 9A and 9B are perspective views respectively illustrating a substrate bonded state and an assembled state of the plug connector;

FIG. 10 is a perspective view of a receptacle connector;

FIG. 11 is a plan view of the receptacle connector;

FIG. 12 is a cross-sectional view taken along an arrow VII-VII in FIG. 10;

FIGS. 13A and 13B are perspective views respectively illustrating a receptacle-side shell and a right surface out of separated left and right surfaces;

FIGS. 14A and 14B are perspective views respectively illustrating a substrate bonded state and an assembled state of the receptacle connector;

FIGS. 15A and 15B are perspective views respectively illustrating a plug connector and a receptacle connector before fitting in a connector device including a heat pass connector according to one embodiment of the present invention;

FIGS. 16A and 16B are perspective views respectively illustrating a plug-side heat dissipation plate and a receptacle-side heat dissipation plate before fitting in the connector device according to the one embodiment of the present invention;

FIG. 17 is a perspective sectional view, taken along a one-dot and dash line VIII-VIII in FIG. 15, at the time of fitting in the connector device including the heat pass connector according to the one embodiment of the present invention;

FIG. 18 is a perspective view illustrating a plug-side heat dissipation plate and a receptacle-side heat dissipation plate at the time of fitting in the connector device including the heat pass connector according to the one embodiment of the present invention;

FIG. 19 is a cross-sectional view, taken along a one-dot and dash line VIII-VIII in FIG. 15, of the connector device including the heat pass connector according to one embodiment of the present invention; and

FIG. 20 is a schematic view illustrating a mechanism of the heat pass connector according to the present invention.

### DESCRIPTION OF THE EMBODIMENTS

### First Embodiment

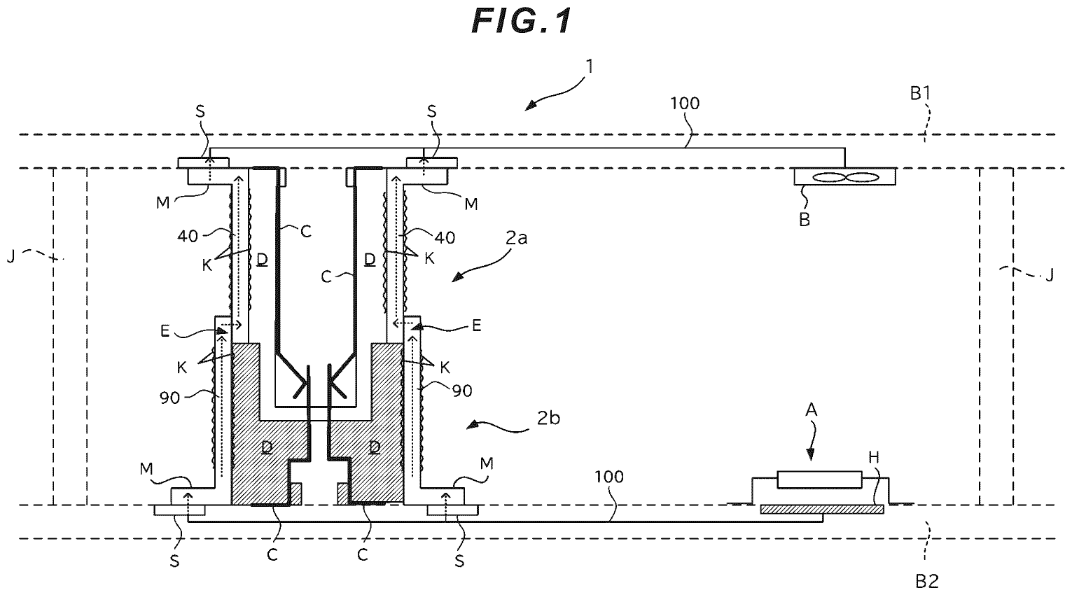

A heat pass connector according to the present invention is a connector in which an effect of dissipating heat on a substrate is enhanced. A mechanism for heat dissipation in a connector device 1 according to a first embodiment including the heat pass connector will be described. First, a configuration of the connector device 1 will be described with reference to FIG. 1. A specific connector device 1 will be described in embodiments described below.

The connector device 1 is provided on a substrate and includes a plug connector 2a provided on a first substrate B1 and a receptacle connector 2b provided on a second substrate B2, which are fitted into each other. The connectors 2a and 2b respectively include contacts C, housings D that house the contacts C, and shells 40 and 90 surrounding and attached to the housings D. The shells 40 and 90 are respectively bonded to shell bonding sections S formed on the substrates B1 and B2. The shell in the plug connector 2a is referred to as a plug-side shell 40, and the shell in the receptacle connector 2b is referred to as a receptacle-side shell 90. Each of the shells 40 and 90 is molded using a highly conductive material. The housing D is molded using an electrically insulating material such as synthetic resin. The contacts C, the housings D, mount sections M, and heat dissipation sections K in the connector device 1 each differ in configuration and shape, although those having the same function are described using the same symbol.

An electronic component A as a heating element is installed on the second substrate B2, and a heat generation section H heated by heat from the electronic component A occurs in the substrate B2 in the vicinity of the electronic component A. A heat transfer path 100 is formed between the heat generation section H and the shell bonding section S in the connector bonded onto the second substrate B2. A heat dissipation member B for heat dissipation is installed on the first substrate B1, and a heat transfer path 100 is also formed between the shell bonding section S in the connector bonded onto the first substrate B1 and the heat dissipation member B. The shell bonding section S and the heat transfer path 100 are formed of a material having conductivity, and an effect of effectively conducting heat between the heat generation section H and the connector device 1 or between the heat dissipation section B and the connector device 1. The shell bonding section S is formed by a substrate pattern (wiring pattern), for example.

The heat transfer path 100 is provided on the substrate using a material having conductivity. The heat transfer path 100 may be formed by a wiring pattern provided on the substrate, or may directly make connection from the heating element such as the electronic component A to the connector or from the heat dissipation member B to the connector using a metal having high thermal conductivity. Heat may be inducted to the connector using a heat exchange member such as a vapor chamber.

Each of the plug-side shell 40 and the receptacle-side shell 90 includes the mount section M for bonding to the substrate and the heat dissipation section K for heat dissipation.

The mount sections M are respectively provided in lower portions of the shells 40 and 90 and soldered to the shell bonding sections S formed on the substrates, thereby bonding the shells 40 and 90 to the substrates.

Each of the shells 40 and 90 has an uneven portion having a large number of concaves and convexes formed on its surface as the heat dissipation section K. The uneven portion is formed so that a surface area increases, thereby making it possible to enhance an effect of heat dissipation. In order to form a concave and convex shape, the surface may be subjected to surface treatment such as plating treatment. As such plating treatment, microfin plating “SUGOHIE” manufactured by EBINAX Co., Ltd. (Ebina Denka Kogyo Co., Ltd.), for example, can be used. In order to form the uneven portion, each of the shells 40 and 90 may be pressed to subject the surface to dowel processing.

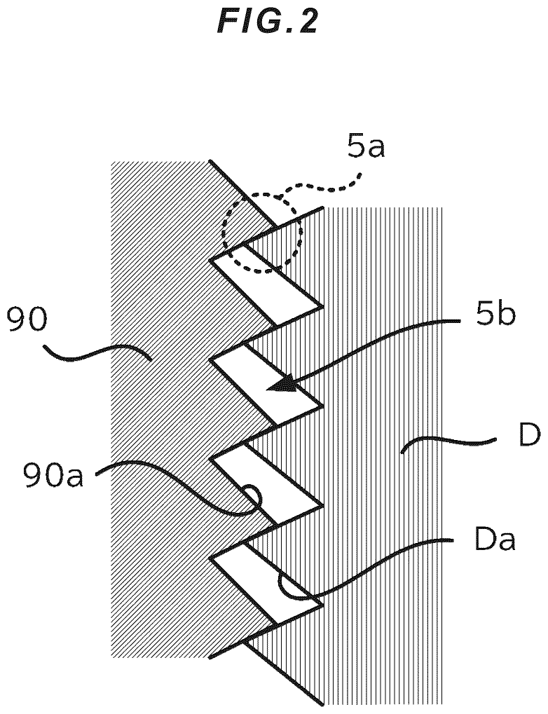

Each of the shells 40 and 90 preferably has a portion that contacts the housing D. This makes it possible to conduct heat from the housing D to each of the shells 40 and 90 having higher thermal conductivity. At this time, each of the shells 40 and 90 is press-fitted into the housing D, so that the housing D and the shell contact each other at an appropriate pressure, thereby making it possible to conduct heat from the housing D to the shell. Each of the shells 40 and 90 also has a concave and convex shape on its inner surface, thereby making it possible to also enhance a heat dissipation effect inside the shell. The housing D and each of the shells 40 and 90 contact each other on a convex surface of the concavo-convex shape and do not contact each other on a concave surface thereof, whereby heat is dissipated by thermal conduction in a contact portion and by convection and radiation in a non-contact portion, making it possible to perform effective heat dissipation that is their combination. The housing D and each of the shells 40 and 90 are press-fitted into each other such that the area of a contact surface therebetween increases, thereby making it possible to enhance thermal conductivity. The housing D may also have a concave and convex shape on its surface. FIG. 2 schematically illustrates part of a cross-sectional view in the contact portion illustrating how the receptacle-side shell 90 having the concave and convex shape on the inner side thereof is press-fitted into the housing D having the concave and convex shape as an example. As illustrated in FIG. 2, each of the shells 40 and 90 and housing D is press-fitted into each other such that a contact surface 5a on their respective convex surfaces increases, thereby making it possible to enhance thermal conductivity and to dissipate heat by convection and radiation in a non-contact portion.

A heat dissipation effect in the connector having a larger surface area as the entire shell out of the connectors 2a and 2b is higher. Accordingly, the connector bonded to the substrate where the heating element is installed preferably has the shell having a larger surface area. In FIG. 1, for example, the receptacle connector 2b bonded to the substrate B2 on the heating element side preferably has a larger surface area than that of the plug connector 2a.

The plug-side shell 40 and the receptacle-side shell 90 include a fitting section E where both the shells 40 and 90 contact and are fitted into each other. The fitting section E has a smooth portion smoothly formed in a contact portion and is configured such that the area of a contact surface increases. This makes it possible to enhance thermal conductivity. In order to form a smooth shape, surface treatment such as plating treatment for smoothing a surface may be performed.

A surface of the contact C is preferably subjected to surface treatment such as plating treatment to have an uneven portion having a large number of concaves and convexes formed thereon. When the uneven portion is formed, a surface area of the contact C increases, so that an effect of heat dissipation is enhanced, making it possible to obtain an effect of heat dissipation at the contact C in addition to heat dissipation in the heat dissipation section K in each of the shells 40 and 90 and to enhance an effect of heat dissipation as the connector device 1. As such plating treatment, microfin plating “SUGOHIE” manufactured by EBINAX Co., Ltd., for example, can be used, like in the heat dissipation section K.

Then, a mechanism for heat dissipation in the heat pass connector according to the present invention will be described with reference to FIG. 1.

In FIG. 1, the plug connector 2a is bonded onto the first substrate B1, the receptacle connector 2b is bonded onto the second substrate B2, and the plug connector 2a and the receptacle connector 2b are fitted into each other in the fitting section E. The electronic component A is installed on the second substrate B2, and the heat dissipation member B such as a fan or a heat sink is installed on the first substrate B1. The heat transfer path 100 is provided between the heat dissipation member B on the first substrate B1 and the shell bonding section S in the plug connector 2a. The heat transfer path 100 is also provided between the heat generation section H in the second substrate B2 and the shell bonding section S in the receptacle connector 2b. On the second substrate B2, heat from the heat generation section H heated by the electronic component A as a heat source is transferred to the shell bonding section S in the receptacle connector 2b along the heat transfer path 100 on the substrate B2 and is transferred to the shell 90 through the mount section M. The heat transferred to the shell 90 is dissipated from the heat dissipation section K in the receptacle-side shell 90. Heat transferred to a portion other than the shell 90 in the receptacle connector 2b is transferred through the contact portion between the housing D and the shell 90, is dissipated from the heat dissipation section K, and is dissipated by convection and radiation in the non-contact portion therebetween.

Heat not dissipated by the receptacle connector 2b is transferred from the fitting section E to the counterpart plug-side shell 40, and is dissipated from the heat dissipation section K in the shell 40. Heat transferred to a portion other than the shell 40 in the plug connector 2a is transferred through the contact portion between the housing D and the shell 40, is dissipated from the heat dissipation section K in the shell 40, and is dissipated by convection and radiation in the non-contact portion therebetween. Heat not dissipated by the plug connector 2a is transferred to the shell bonding section S through the mount section M in the shell 40, and can be dissipated from the heat dissipation member B provided on the substrate B1 through the heat transfer path 100 on the plug connector 2a side.

Part of the heat from the heat generation section H is also transferred to the contact C having a heat dissipation function and is dissipated from the surface of the contact C. Heat not dissipated at the contact C in the receptacle connector 2b is transferred to the contact C in the plug connector 2a through a contact portion between the connector 2a and the connector 2b, and can also be dissipated at the contact C in the plug connector 2a.

Thus, heat on the substrate can be dissipated using the heat pass connector according to the present invention.

With the above-described configuration, the heat on the substrate can be dissipated from the connector device 1. The above-described heat pass connector according to the present invention can be adopted as various types of connectors.

Hereinafter, a preferred embodiment of the heat pass connector according to the present invention will be described with reference to the drawings.

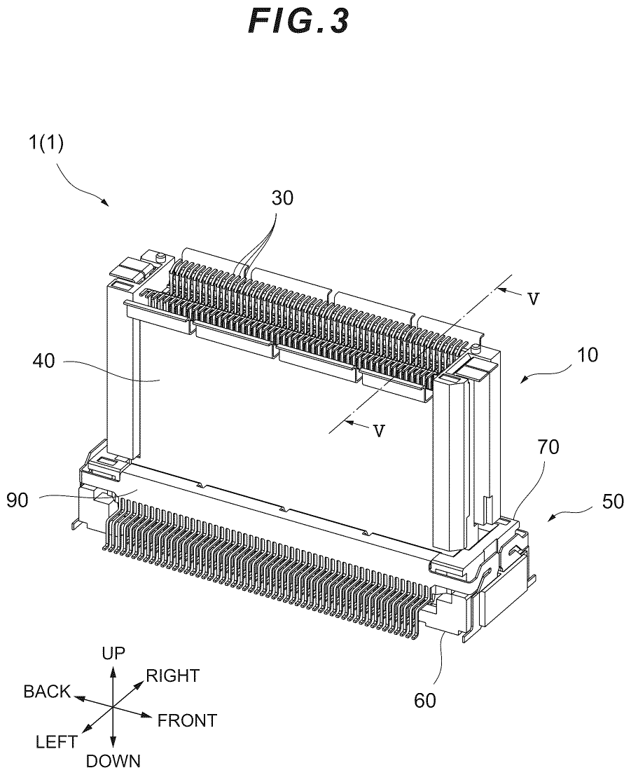

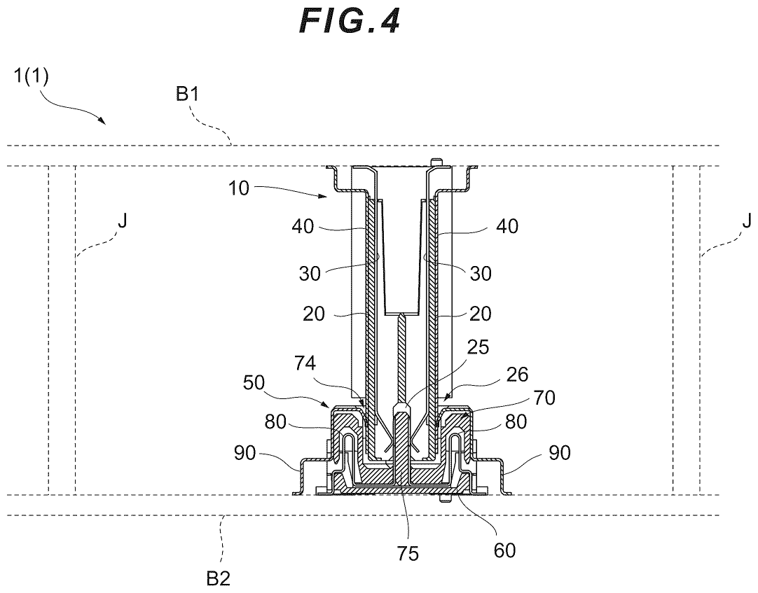

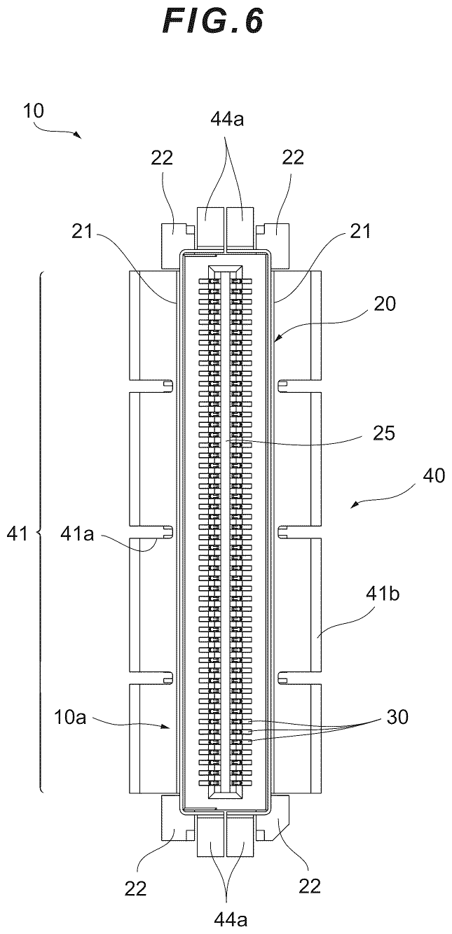

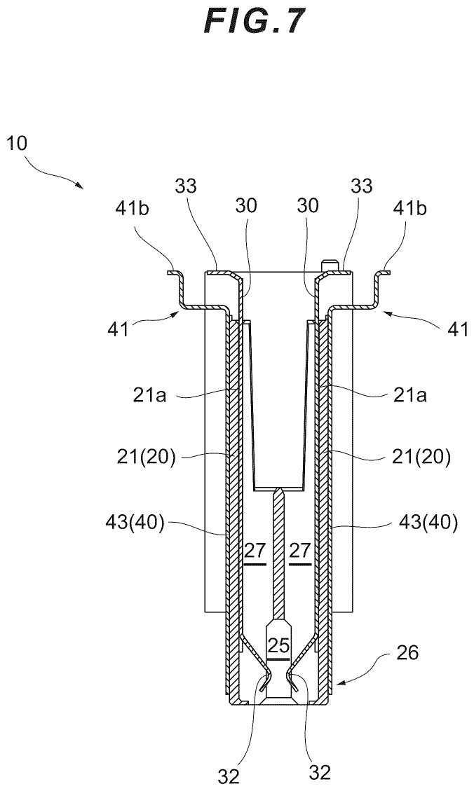

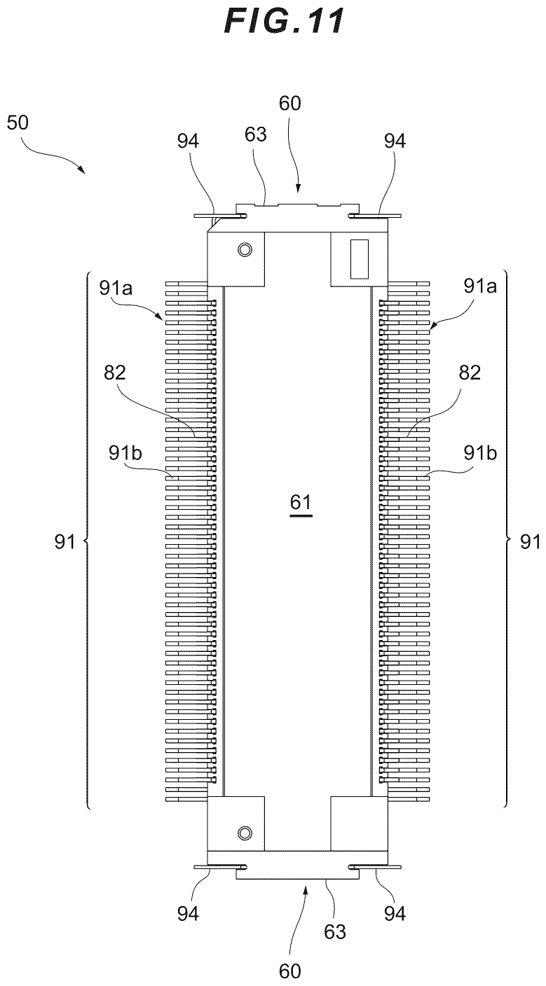

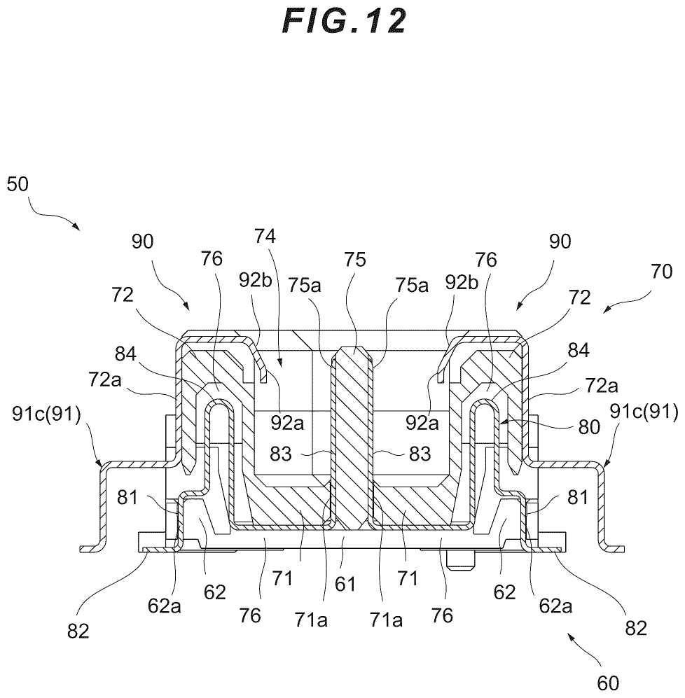

An example in which a heat pass connector according to a first embodiment of the present invention is adopted for a connector device 1 (1) including a floating connector (specifically, a receptacle connector 50 having a floating structure) is illustrated in FIGS. 3 to 14, and an entire configuration of the connector device 1 (1) will be described with reference to FIGS. 3 and 4 among the drawings.

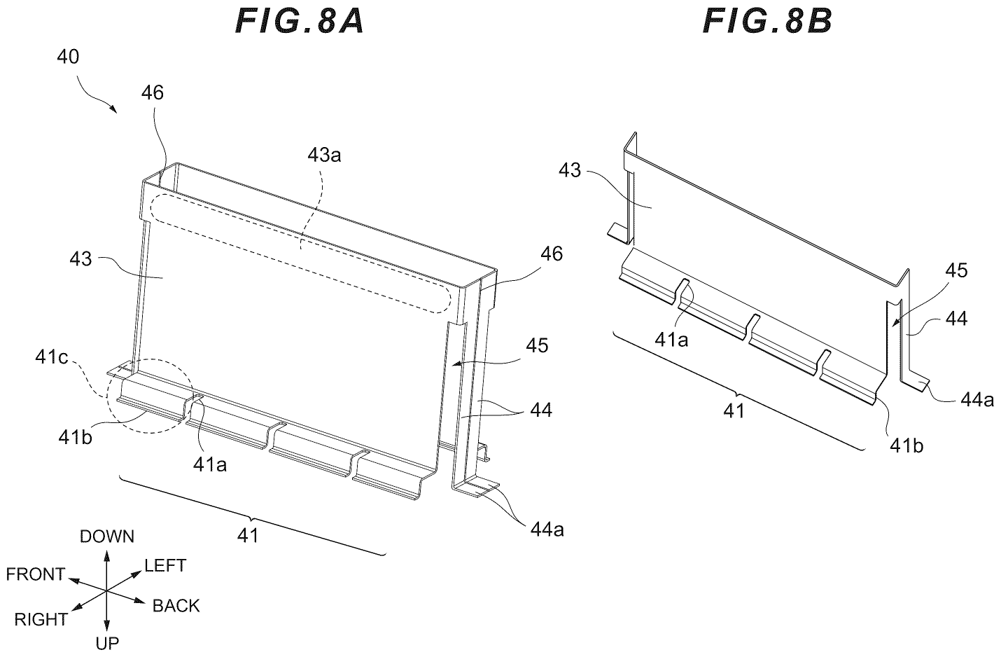

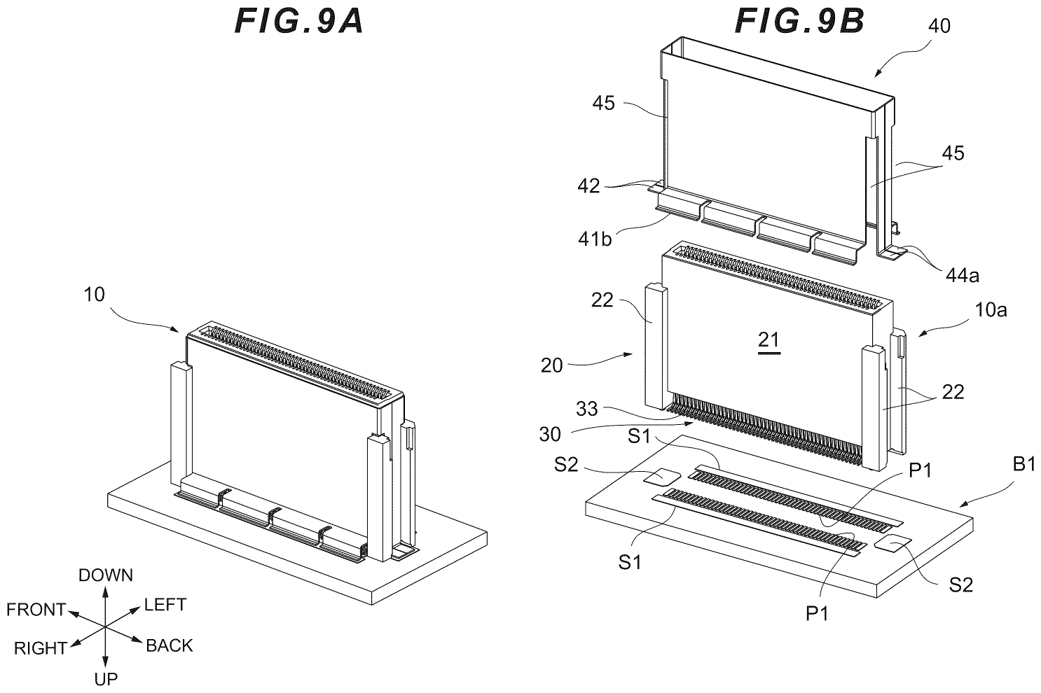

The connector device 1 (1) includes a plug connector 10 provided on the first substrate B1 (see FIG. 4) and the receptacle connector 50 provided on the second substrate B2 (see FIG. 4). Both the connectors 10 and 50 are fitted into each other in a direction perpendicular to a surface of each of the substrates B1 and B2, whereby the first substrate B1 and the second substrate B2 can be electrically connected to each other. A spacer J for maintaining a predetermined distance between both the first substrate B1 and the second substrate B2 is arranged between the substrates B1 and B2. In the following description, for convenience, front-back, left-right, and up-down directions are defined with states illustrated in FIGS. 3, 5, 10, 13, and 14 as a reference. As directions indicated by arrows illustrated in each of FIGS. 3, 5, 10, 13 and 14, a fitting direction (height direction) between the connectors 10 and 50, a longitudinal direction (width direction) of each of the connectors 10 and 50, and a direction perpendicular to the longitudinal direction (thickness direction) of each of the connectors are respectively referred to as an up-down direction, a front-back direction, and a left-right direction. Each of FIGS. 8 and 9 illustrates a drawing in which the connection side to a substrate is drawn on the lower side of the paper. Symbols used in the connector device 1 are also respectively used for components having the same functions and effects in the connector device 1 (1), but do not mean that the components have the same configurations.

The plug connector 10 includes a plug-side contact 30, a plug-side housing 20 that houses the plug-side contact 30, and the plug-side shell 40 surrounding the plug-side housing 20 and press-fitted into the plug-side housing 20. The receptacle connector 50 includes a receptacle-side contact 80, a fixed-side housing 60 and a movable-side housing 70 that house the receptacle-side contact 80, and a receptacle-side shell 90 surrounding the housings 60 and 70 and press-fitted into the fixed-side housing 60.

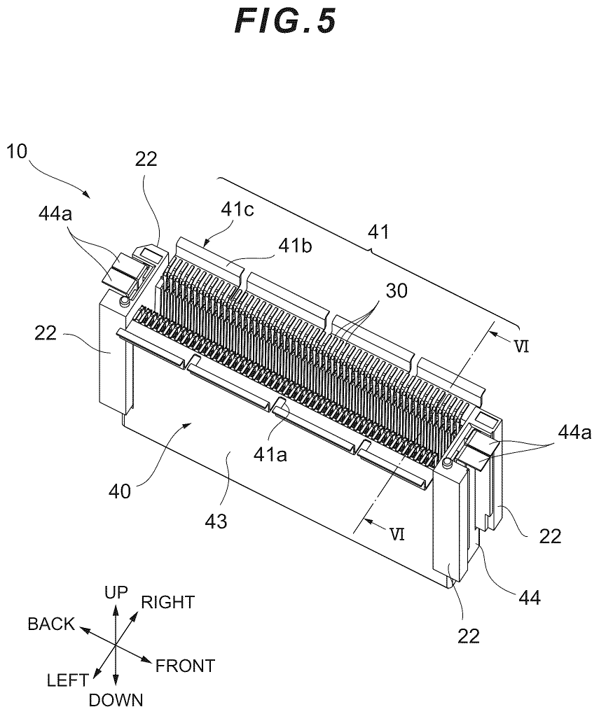

First, a configuration of the plug connector 10 will be described while additionally referring to FIGS. 5 to 7 and 9. The plug connector 10 includes the plug-side shell 40 fixed on the first substrate B1 and a plug connector body 10a (see FIG. 9), and the plug connector body 10a includes a plug-side housing 20 and a plurality of plug-side contacts 30 held in an aligned state of two rows in the longitudinal direction (front-back direction) of the plug-side housing 20.

The plug-side housing 20 is molded using an electrically insulating material such as synthetic resin, and includes a plug-side housing body 21 formed in a landscape-oriented rectangular parallelepiped shape and a pair of fixing sections 22 provided at front and back ends of the housing body 21.

The plug-side housing body 21 is formed in a substantially rectangular box shape with an opened lower surface as a whole. The housing body 21 is concavely provided with a receiving space 25 (a space in which a protrusion 75 in a receptacle contact 50 is received) having a rectangular cross section opened downward. A lower surface of the plug-side housing body 21 is formed as a fitting projection 26 having an outer shape into which the receptacle connector 50 is fittable. A surface of the housing body 21 may partially have a concave and convex shape, like in the shell 40 described below.

The housing body 21 is provided with contact holding grooves 21a for respectively press-fitting and holding the plug-side contacts 30 in two rows in the left-right direction and at a predetermined array pitch in the front-back direction, and each of the contact holding grooves 21a is partitioned by a partition plate except around its contact portion with the receptacle-side contact 80.

Each of the fixing sections 22 has a protrusion having a substantially rectangular box shape formed therein along an end of the housing body 21, and is attached with a longitudinal direction of the substantially rectangular box shape aligned with the up-down direction. The substrate side of the fixing section 22 is formed to have a length in which it contacts the substrate when the housing body 21 is bonded to the substrate, and the fitting side thereof is formed to be shorter than the end of the housing body 21. When the fixing section 22 is inserted into a mounting hole 45 provided at an end of the shell 40 while protruding outward to bond the shell 40 to the substrate, the length and the thickness in the up-down direction of the fixing section 22 are formed to match the position and the width of the mounting hole 45 such that the connector body 10a including the housing 20 is also fixed to the substrate at an appropriate pressure with an appropriate pressure difference between the shell 40 and the housing 20 due to the protrusion and the housing 20 and the shell 40 are appropriately pressed against each other.

The plug-side contact 30 is formed into a predetermined shape by subjecting a thin flat plate made of a conductive material such as a metal to press working (punching and bending). The plug-side contact 30 is subjected to required surface treatment (plating treatment) for coating its surface with a thin film made of gold (Au) or the like. At least part of a surface of the plug-side contact 30 is subjected to plating treatment to have an uneven portion having a concave and convex shape formed thereon, and has a heat dissipation function. This effect will be described in more detail below.

The plug-side contact 30 includes a contact section 32 that is partially press-fitted into the contact holding groove 21a in the plug-side housing 20 and is elastically displaced in a substantially plate thickness direction on the lower side thereof and a lead section 33 that bends in an L-shape on the upper side thereof from its portion press-fitted into the contact holding groove 21a and extends outward. The contact section 32 is formed to bend in a substantially v-shape with a convex portion directed toward the receiving space 25 side, and is formed as a site where its portion most protruding toward the receiving space 25 side contacts the counterpart receptacle-side contact 80. The lead section 33 is soldered and electrically connected to a substrate pattern (wiring pattern P) formed on the first substrate B1.

The plug-side shell 40 will be described while additionally referring to FIG. 8. Although FIG. 8 illustrates the substrate side of the plug-side shell 40 as the lower side of the paper, directions will be described by referring to a longitudinal direction (width direction), a height direction, and a direction perpendicular to the longitudinal direction (thickness direction), respectively, as a front-back direction, an up-down direction, and a left-right direction according to arrows illustrated in FIG. 8.

The plug-side shell 40 is molded using a highly conductive material, e.g., a copper alloy. The plug-side shell 40 has a substantially rectangular parallelopiped shape with upper and lower openings, is configured to surround the plug-side housing 20 and be press-fittable into the housing 20, and has a side wall 43 as a wall surface in the longitudinal direction (front-back direction) and a front-back wall 44 with front and back wall surfaces. The plug-side shell 40 includes a mount section 41 that extends outward from the side wall 43, further bends in an L-shape toward the substrate, and extends outward and a pair of mounting holes 45 formed such that the fixing sections 22 in the plug-side housing body 21 are respectively press-fittable thereinto with an end of the front-back wall 44 hollowed out from the substrate side. The shell 40 is press-fitted into and fixed to the housing 20 by the mounting holes 45. The plug-side shell 40 is configured to be disassemblable in the direction perpendicular to the longitudinal direction (left-right direction) by a disassembly line 46 illustrated in FIG. 8.

The front-back wall 44 has a grounding section 44a that bends in an L shape outward on the substrate side thereof, and the grounding section 44a is soldered to a substrate pattern (shell bonding section) for bonding the conductive shell 40 formed on the first substrate B1.

The plug-side shell 40 has an uneven portion having a concave and convex shape formed thereon by plating treatment entirely or partially on its front and back surfaces, but is configured to be contactable with the receptacle-side shell 90 in a wide area because a contact surface 43a, on which the side wall 43 contacts the receptacle-side shell 90 when fitted thereinto, is subjected to smoothing plating treatment for smoothing the surface.

The mount section 41 includes a mount foot section 41c and a mount grounding section 41b at an upper end (on the substrate side) of the mount foot section 41c. The mount section 41 is notched from an upper end (on the substrate side) of the mount section 41 to its portion that starts to bend in an L shape outward from the side wall 43 by a plurality of notch sections 41a spaced apart from one another in the longitudinal direction (front-back direction), and a plurality of mount foot sections 41c are formed by a remaining portion not notched. The mount grounding section 41b is soldered to a conductive substrate pattern (shell bonding section) formed on the first substrate B1.

An effect of the uneven portion formed by performing plating treatment in the plug-side contact 30 will be described. The plug-side contact 30 is formed such that a surface area of the mount foot sections 41c becomes large, thereby making it possible to enhance the efficiency of heat dissipation. However, even when the notch sections 41a are widely spaced apart from one another and the surface area of the mount foot sections 41c cannot be made sufficiently large due to reasons such as a difficulty in wiring to the substrate pattern (wiring pattern P) to the plug-side contact 30, the plug-side contact 30 has the uneven portion, thereby making it possible to promote heat dissipation in the plug-side contact 30.

Then, an assembly of the plug connector 10 will be described with reference to FIG. 9. Although FIG. 9 also illustrates the substrate side as the lower side of the paper, similarly to FIG. 8, directions will be described by referring to a longitudinal direction (width direction), a height direction, and a direction perpendicular to the longitudinal direction (thickness direction) of the shell 40, respectively, as a front-back direction, an up-down direction, and a left-right direction according to arrows illustrated in FIG. 9.

The plug connector body 10a is fixed on the first substrate B1 by soldering the lead section 33 in the plug-side contact 30 to a substrate pattern (wiring pattern P1) on the substrate formed at the same array pitch as that in the plug-side contact 30. The fixing sections 22 in the plug connector body 10a are respectively inserted into and fixed to the disassembled left and right mounting holes 45 in the plug-side shell 40. The plug connector 10 can be installed on the first substrate B1 by soldering the mount grounding section 41b in the shell 40 to a substrate pattern (shell bonding section S1) on the substrate and soldering the grounding section 44a in the shell 40 to a substrate pattern (shell bonding section S2) on the substrate.

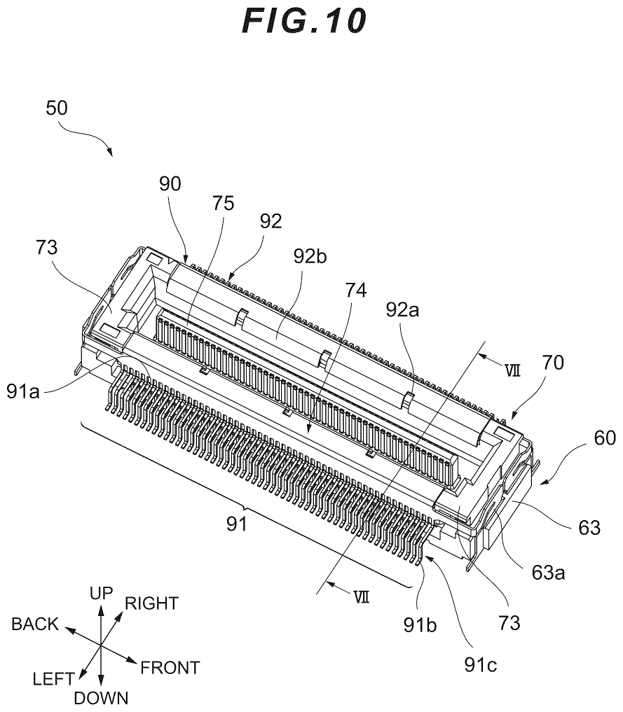

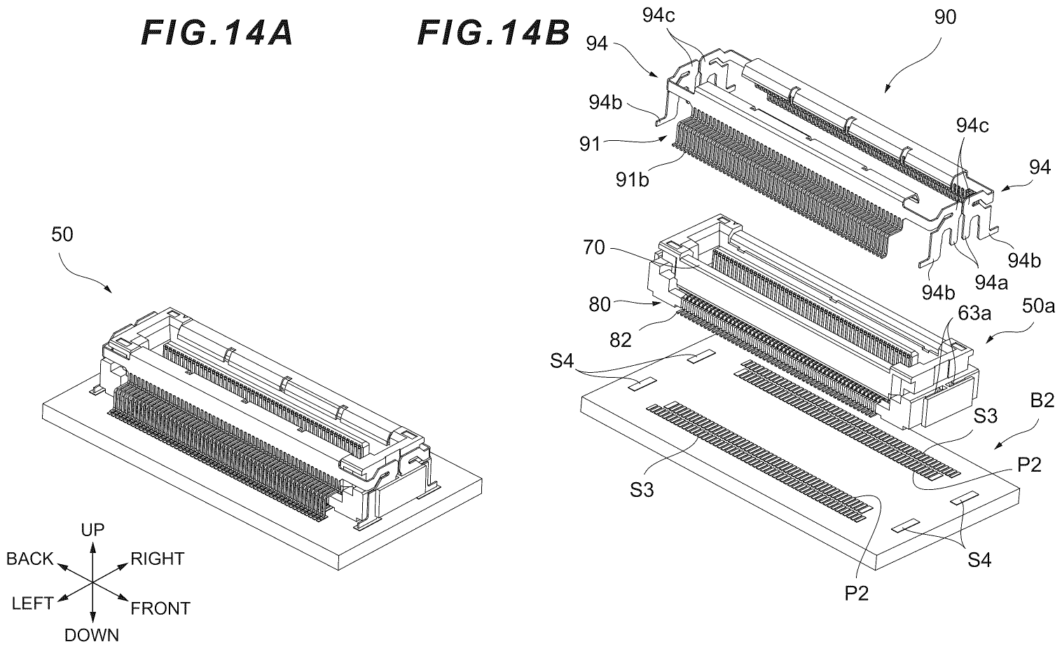

Then, a configuration of the receptacle connector 50 will be described while additionally referring to FIGS. 10 to 12 and 14. The receptacle connector 50 includes a receptacle-side shell 90 fixed on the second substrate B2 and a receptacle connector body 50a (see FIG. 14), and the receptacle connector body 50a includes the fixed-side housing 60, a movable-side housing 70 attached to the fixed-side housing 60 to be relatively movable, and a plurality of receptacle-side contacts 80 provided to straddle both the housings 60 and 70 and held in an aligned state of two rows in the longitudinal direction (front-back direction) of each of the housings 60 and 70.

The fixed-side housing 60 is molded using an electrically insulating material such as synthetic resin, and has a substantially rectangular plate-shaped base wall 61 that vertically opposes the second substrate B2, left and right walls 62 provided at left and right ends of the base wall 61, and front and back walls 63 provided on the front and back sides of the base wall 61. The front and back walls 63 have a pair of shell mounting grooves 63a for respectively inserting insertion sections 94a in the receptacle-side shell 90 from above and press-fitting and fixing the shell 90 into and to the fixed-side housing 60. Inside the left and right walls 62, a plurality of contact holding grooves 62a that penetrate therethrough in the up-down direction and can respectively hold the receptacle-side contacts 80 are formed in two rows in the left-right direction and at a predetermined array pitch in the front-back direction.

The movable-side housing 70 is molded using an electrically insulating material such as synthetic resin, and includes a body wall 71 that vertically opposes the base wall 61 in the fixed-side housing 60, protection walls 72 that are respectively provided at left and right ends of the body wall 71 and bend in an inverted U-shape, and upstanding walls 73 respectively provided at front and back ends of the body wall 71, and has a fitting recess 74 (a space that receives the fitting projection 26 in the plug connector 10), which is surrounded by their wall surfaces and opened upward, defined at its center. The convex-shaped protrusion 75, which protrudes upward from the body wall 71, is formed in the fitting recess 74. On left and right side surfaces of the protrusion 75, a plurality of contact holding grooves 75a, which are formed in a cross-sectional concave shape and extend in the up-down direction, are formed at a predetermined array pitch in the front-back direction. The body wall 71 has a plurality of contact holding holes 71a, which penetrate therethrough in the up-down direction, formed therein at a predetermined array pitch in the front-back direction. The contact holding holes 71a and the contact holding grooves 75a are in a positional relationship in which they are aligned in the up-down direction and communicate with each other. An outer surface of the protection wall 72 partially contacts an inner surface of a side wall 93 in the shell 90 when the shell 90 is attached. Their contact surface may partially have a concave and convex shape, similarly to that in the shell 90 described below. In the case, the shell 90 is preferably attached in a semi-fitting state as described above when attached.

The movable-side housing 70 is provided while floating upward from the fixed-side housing 60 via the plurality of receptacle-side contacts 80. Between the lower surface side of the movable-side housing 70 and the upper surface side of the fixed-side housing 60, an elastic section housing space 76 for housing an elastically deformed portion (an elastic section 84 described below) in the receptacle-side contact 80 is defined.

The receptacle-side contact 80 is formed into a predetermined shape by subjecting a thin flat plate made of a conductive material such as a metal to press working (punching and bending). The receptacle-side contact 80 is subjected to required surface treatment (plating treatment) for coating its surface with a thin film made of gold (Au) or the like. The contact 80 has an uneven portion having a concave and convex shape formed thereon by subjecting at least part of its surface to plating treatment, similarly to the plug-side contact 30. This effect is similar to that described in the plug-side contact 30, and description thereof is omitted.

The receptacle-side contact 80 includes a holding section 81 press-fitted into the contact holding groove 62a in the fixed-side housing 60 and extending in the up-down direction, a lead section 82 that bends in a substantially L shape from a lower end of the holding section 81 and extends outward in the left-right direction, a contact section 83 press-fitted into the contact holding groove 75a, and an elastic section 84 that is elastically deformable in the up-down direction, the left-right direction, and the front-back direction by connecting an upper end of the holding section 81 and a lower end of the contact section 83 to each other.

The elastic section 84 is a portion (freely movable portion) that is not fixed to either of the fixed-side housing 60 and the movable-side housing 70 but is loosely inserted between the upper surface side of the fixed-side housing 60 and the lower surface side of the movable-side housing 70 and is a freely elastically deformable.

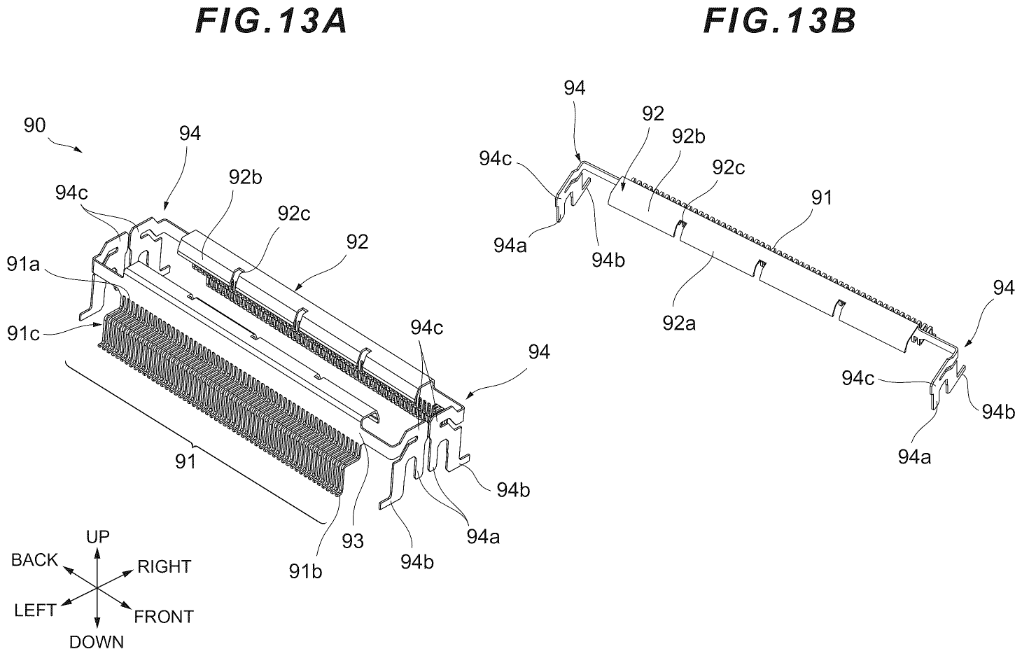

The receptacle-side shell 90 will be described while additionally referring to FIG. 13.

The receptacle-side shell 90 is molded using a highly conductive material, e.g., a copper alloy. The receptacle-side shell 90 surrounds the fixed-side housing 60 and the movable-side housing 70, is press-fitted into and attached to the fixed-side housing 60, has a side wall 93 having a substantially rectangular shape in the longitudinal direction (front-back direction) and a pair of fixtures 94 on the front and back sides, and includes a mount section 91 that extends outward from the side wall 93, further bends in an L shape toward the substrate, and extends outward in a lower portion (on the substrate side) of the side wall 93. The receptacle-side shell 90 is configured to be disassemblable in the left-right direction in FIG. 13.

Each of the fixtures 94 includes a fixed end wall 94c that can suppress excessive movement (floating) in the front-back direction of the movable-side housing 70 relative to the fixed-side housing 60, a pair of left and right insertion sections 94a that extend downward from the fixed end wall 94c and are respectively inserted into the shell mounting grooves 63a in the fixed-side housing 60, and a pair of left and right grounding tools 94b that extend from the fixed end wall 94c toward the substrate side and bend outward in the left-right direction. The grounding tools 94b are soldered to a substrate pattern (shell bonding section) for bonding the conductive shell 90 formed on the second substrate B2.

An upper portion (on the fitting side) of the side wall 93 includes an introduction section 92b that bends inward in an L-shape and is further folded downward obliquely toward the fitting recess 74, a contact surface 92a that extends vertically downward from a lower end of the introduction section 92b and is formed to be contactable with the contact surface 43a of the plug-side shell 40, and a cutout section 92c cut out from the contact surface 92a to the introduction section 92b. The introduction section 92b has a shape folded obliquely downward, thereby making it possible to smoothly perform fitting of the fitting projection 26 in the plug connector 10 into the fitting recess 74.

Although the receptacle-side shell 90 has a concave and convex shape formed by plating treatment in the whole or part of its front and back surfaces, the contact surface 92a of the receptacle-side shell 90 is subjected to smoothing plating treatment for smoothing the surface and is configured to be contactable with the contact surface 43a of the plug-side shell 40 in a wide area. An inner surface of the side wall 93 contacts an outer surface of each of the protection wall 72 of the movable-side housing 70 when the shell 90 is attached.

The mount section 91 includes a mount foot section 91c and a mount grounding section 91b at an end on the substrate side of the mount foot section 91c. The mount section 91 is notched from an end on the substrate side of the mount section 91 to its portion that starts to bend in an L shape outward from the side wall 93 by a plurality of notch sections 91a spaced apart from one another in the longitudinal direction (front-back direction). A plurality of mount foot sections 91c are formed by a remaining portion not notched. A mount section in a shell provided for a connector having a floating structure is preferably provided with more notch sections than those in a shell provided for a connector not having a floating structure. The larger the number of notch sections to be provided is, the more easily foot sections are elastically deformed. When the mount section has an L-shaped bending shape, the foot sections are easily elastically deformed, thereby making it possible to enhance followability to floating of the shell. The mount grounding section 91b is soldered to a conductive substrate pattern (shell bonding section) formed on the second substrate B2.

Then, an assembly of the receptacle connector 50 will be described with reference to FIG. 14. In FIG. 14, directions will be described by referring to a height direction with the substrate side as the lower side, a longitudinal direction (width direction) of the shell 90, and a direction perpendicular to the longitudinal direction (thickness direction) of the shell 90, respectively, as an up-down direction, a front-back direction, and a left-right direction, like in FIG. 10.

The receptacle-side connector body 50a is fixed on the second substrate B2 by soldering the lead section 82 in the receptacle-side contact 80 to a substrate pattern (wiring pattern P2) on the substrate formed at the same array pitch as that in the receptacle-side contact 80. The disassembled left and right insertion sections 94a in the receptacle-side shell 90 are respectively inserted into and fixed to the shell mounting grooves 63a in the receptacle connector body 50a. The receptacle connector 50 can be installed on the second substrate B2 by soldering the mount grounding section 91b in the shell 90 to a substrate pattern (shell bonding section S3) on the substrate formed in the same array pitch as that in the mount foot section 91c and soldering the grounding tools 94b in the shell 90 to a substrate pattern (shell bonding sections S4) on the substrate.

Then, a method for fitting both the connectors 10 and 50 into each other will be described while referring to FIGS. 3 and 4 again.

In order to connect both the connectors 10 and 50 to each other, the plug connector 10 and the receptacle connector 50 are vertically aligned. That is, the fitting projection 26 in the plug connector 10 and the fitting recess 74 in the receptacle connector 50 are vertically aligned. At this time, smooth alignment is possible by fitting the plug connector 10 into the receptacle connector 50 along the introduction section 92b in the shell 40.

Then, when the fitting projection 26 in the plug connector 10 is fitted into the fitting recess 74 in the receptacle connector 50, as illustrated in FIG. 4, the protrusion 75 in the receptacle connector 50 is inserted into the receiving space 25 in the plug connector 10. At this time, the contact section 32 in the plug-side contact 30 slides on the contact section 83 in the receptacle-side contact 80 in an elastically pressed state.

When the fitting between the fitting projection 26 in the plug connector 10 and the fitting recess 74 in the receptacle contact 50 is further advanced to reach a predetermined fitting state (e.g., a state where a distance between both the substrates is a predetermined distance by the spacer J disposed between the substrates, as illustrated in FIG. 4), a position between both the connectors 10 and 50 is defined, and a contact state between the plug-side contact 30 and the receptacle-side contact 80 is held. When the plug-side contact 30 and the receptacle-side contact 80 elastically contact each other with an appropriate contact force, both the connectors 10 and 50 are electrically connected to each other, enabling transmission and reception of a power supply and transmission of a signal between both the substrates.

In such a fitting state, the plug-side shell 40 and the receptacle-side shell 90 are brought into contact with and fitted into each other. Both the shells 40 and 90 are brought into contact with and fitted into each other in a wide area, thereby making it possible to conduct heat from a shell attached on a substrate with a heat source to a counterpart shell.

Even if a fitting position between the plug connector 10 and the receptacle connector 50 deviates in the front-back, left-right, or up-down directions relative to a normal position in the fitting state between both the connectors 10 and 50, the elastic section 84 in the receptacle-side contact 80 is elastically deformed in the front-back, left-right, and up-and-down directions by following the deviation in position, and the movable-side housing 70 moves relative to the fixed-side housing 60, thereby making it possible to absorb the deviation in position while maintaining a contact state between the plug-side contact 30 and the receptacle-side contact 80. The shells 40 and 90 surrounding and attached to the housings 20, 60, and 70 can absorb the deviation in the position while maintaining a contact state between the housings 20, 60 and 70 and the shells 40 and 90 when the foot sections 41c and 91c formed in the mount sections 41 and 91 are elastically deformed to follow the deviation in position. The large number of foot sections 91c formed in the mount section 91 in the shell 90 attached to the connector 50 including the movable-side housing 60 are easily elastically deformed, to easily follow the deviation in position, thereby making it possible to absorb the deviation in position while maintaining the contact state between the housings 20, 60 and 70 and the shells 40 and 90.

Then, a method for heat dissipation on a substrate will be described according to the present embodiment. As an example, a case where a heat generation section H occurs on the first substrate B1.

The plug connector 10 is bonded onto the first substrate B1, the receptacle connector 50 is bonded onto the second substrate B2, and the connectors 10 and 50 are fitted into each other by the fitting projection 26 and the fitting recess 74. The plug connector 10 bonded to the substrate B1 in which the heat generation section H is installed is configured to have a larger surface area than that of the counterpart receptacle connector 50. Heat from the heat generation section H is transferred to the substrate patterns (shell bonding sections S1 and S2) in the plug connector 10 along the heat transfer path 100 formed on the first substrate B1, and is also transferred to the shell 40 through the mount section 41. The heat transferred to the shell 40 is dissipated from the uneven portion formed on the surface of the shell 40. Heat transferred to a portion other than the shell 40 in the plug connector 10 is transferred to the shell 40 from a contact surface between the housing 20 and the shell 40, is dissipated from the uneven portion formed in the shell 40, and is dissipated by convection and radiation in a non-contact portion. Part of the heat from the heat generation section H is also transferred to the contact 30, and is dissipated from the uneven portion formed on the surface of the contact 30.

Heat not dissipated by the plug connector 10 is transferred from the contact surface 43a of the plug-side shell 40 to the contact surface 92a of the receptacle-side shell 90 as contact surfaces at the time of fitting, and is dissipated from the uneven portion on the shell 90. Heat transferred to a portion other than the shell 90 in the receptacle connector 50 is transferred to the shell 90 from a contact surface between the housings 60 and 70 and the shell 90, is dissipated from the uneven portion formed on the shell 90, and is dissipated by convection and radiation in a non-contact portion. Further, heat transferred from the contact 30 through a contact portion with the contact 80 is also dissipated from the uneven portion formed on the surface of the contact 80.

Heat not dissipated by the receptacle connector 50 is transferred to the shell bonding sections S3 and S4 through the mount section 91, and is dissipated from the heat dissipation member B provided in the substrate B2 through the heat transfer path 100 on the receptacle connector 50 side.

In the above embodiment, part of heat is dissipated from the uneven portion formed by plating treatment on each of the surfaces of the plug-side contact 30 and the receptacle-side contact 80. However, at least one of the plurality of contacts 30 and 80 may be formed as a heat dissipation contact pin dedicated for heat dissipation. The plurality of contacts may be configured such that wiring contact pins and heat dissipation contact pins are alternately arranged. When configured such that the wiring contact pins and the heat dissipation contact pins are alternately arranged, the plurality of contacts can be made to have a heat dissipation function while reducing crosstalk that occurs when wiring contacts are close to one another. Further, the heat transfer path 100, through which heat from the heat generation section on the substrate is conducted, may be connected to a connection portion between the heat dissipation contact pins and the substrate, like in the shell.

### Second Embodiment

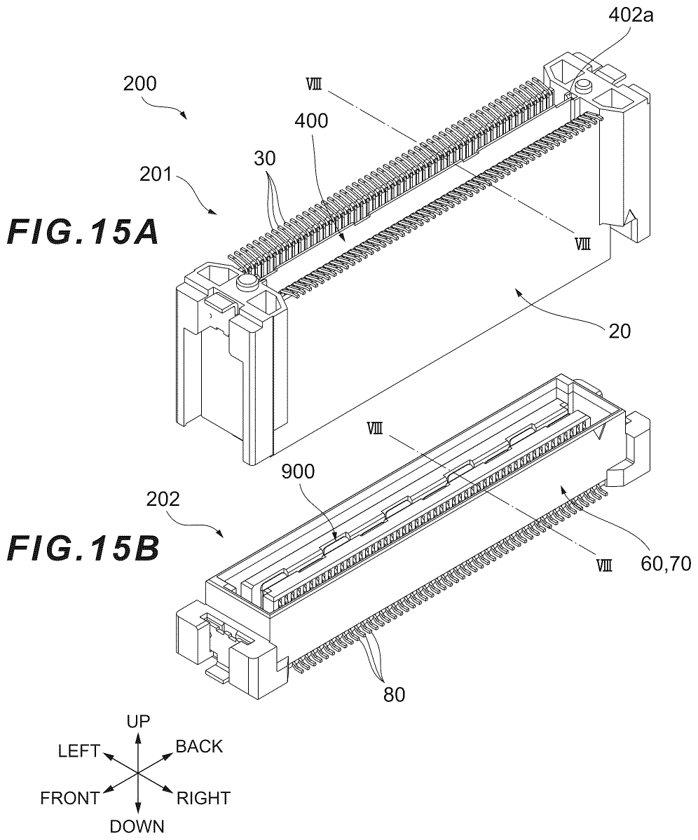

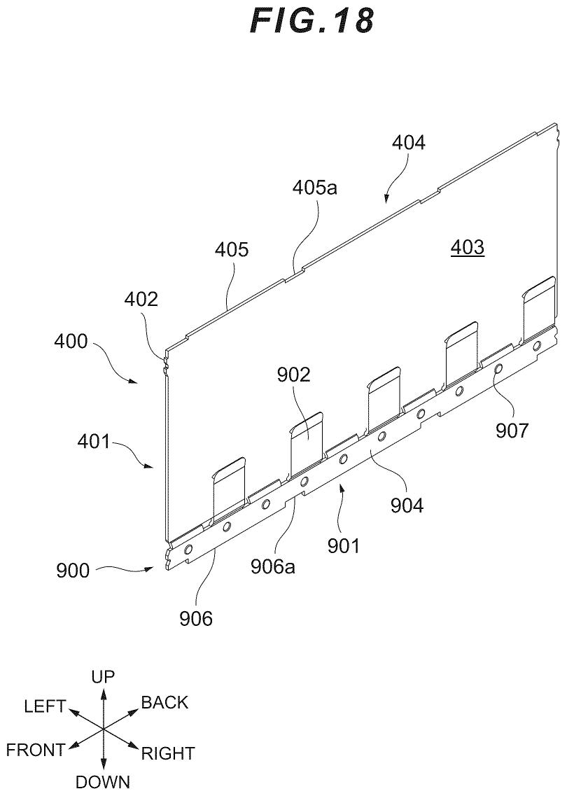

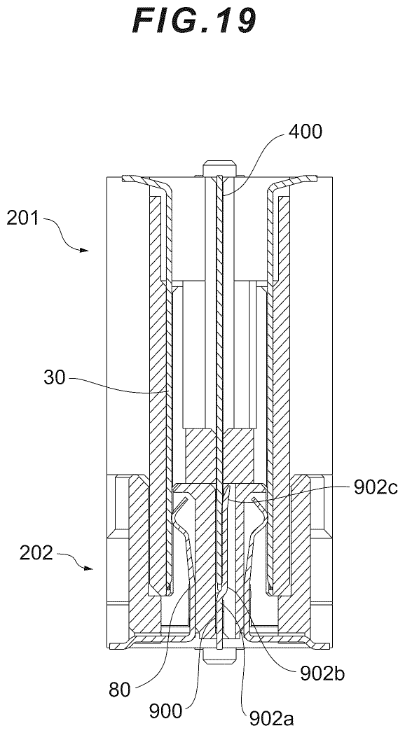

Then, a heat pass connector according to a second embodiment will be described with reference to FIGS. 15 to 20. A connector device 200 as the heat pass connector according to the second embodiment has a configuration in which a plug-side heat dissipation plate 400 and a receptacle-side heat dissipation plate 900 are respectively provided in the vicinities of the centers of connectors in place of the shells 40 and 90 respectively provided outside the housing 20 in the plug connector 10 and the housings 60 and 70 in the receptacle-side connector 50 in the first embodiment. In this configuration, a contact 30 is arranged outside the plug-side heat dissipation plate 400 when a plug connector 201 is installed on a substrate, a housing 20 houses the plug-side heat dissipation plate 400 and the contact 30, a contact 80 is arranged outside the receptacle-side heat dissipation plate 900 when a receptacle connector 202 is installed on the substrate, and housings 60 and 70 house the receptacle-side heat dissipation plate 900 and the contact 80. Although details of the present embodiment will be described below, descriptions that overlap those in the first embodiment are omitted as needed in the following description. In the following description, for convenience, front-back, left-right, and up-down directions are defined with states illustrated in FIGS. 15 to 18 as a reference, and a fitting direction (height direction) between the connectors 201 and 202, a longitudinal direction (width direction) of each of the connectors, and a direction perpendicular to the longitudinal direction (a thickness direction) of each of the connectors are respectively referred to as the up-down direction, the front-back direction, and the left-right direction as directions indicated by arrows illustrated in each of FIGS. 15 to 18.

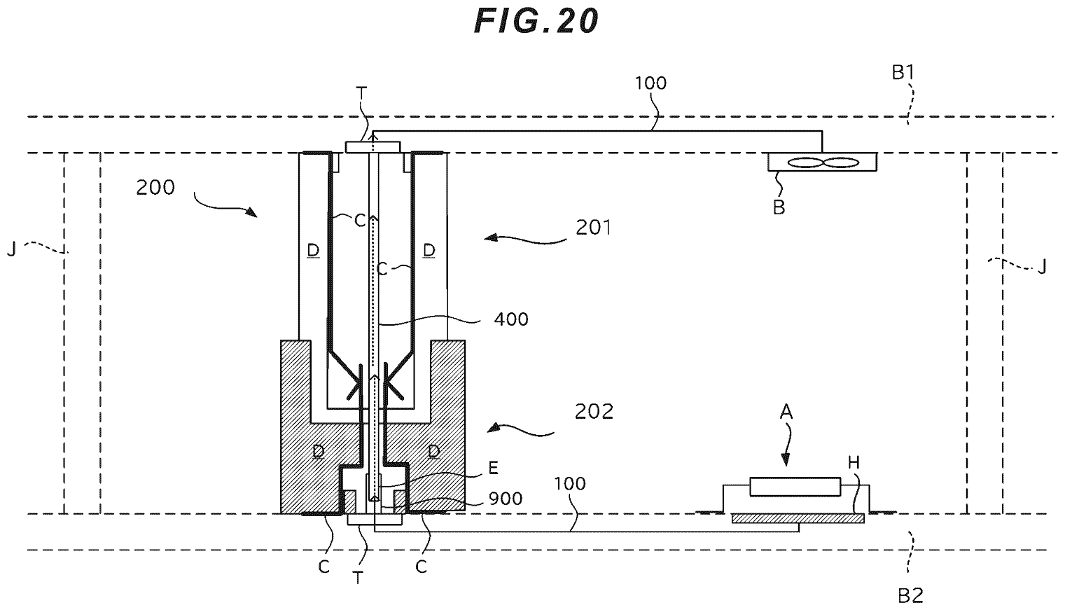

First, a mechanism for heat dissipation in the connector device 200 will be described with reference to FIG. 20. The specific connector device 200 will be described in the embodiment described below.

The connector device 200 are provided on the substrate and includes the plug connector 201 provided on a first substrate B1 and the receptacle connector 202 provided on a second substrate B2, which are fitted into each other. The plug connector 201 includes the plug-side heat dissipation plate 400, a contact C arranged outside the plug-side heat dissipation plate 400, and a housing D that houses the plug-side heat dissipation plate 400 and the contact C. The receptacle connector 202 includes the receptacle-side heat dissipation plate 900, a contact C arranged around the receptacle-side heat dissipation plate 900, and a housing D that houses the receptacle-side heat dissipation plate 900 and the contact C. The heat dissipation plates 400 and 900 are respectively bonded to heat dissipation plate bonding sections T formed on the substrates B1 and B2. The heat dissipation plates 400 and 900 achieve a similar effect to that of the shell in the first embodiment, and are molded using a highly conductive material. The housing D is molded using an electrically insulating material such as synthetic resin.

An electronic component A as a heating element is installed on the second substrate B2, and a heat generation section H heated by heat from the electronic component A occurs in the substrate in the vicinity of the electronic component A, like in the first embodiment. A heat transfer path 100 is formed between the heat generation section H and the heat dissipation plate bonding section T in the connector 202 bonded onto the second substrate B2. A heat dissipation member B for heat dissipation is installed on the first substrate B1, and a heat transfer path 100 is also formed between the heat dissipation plate bonding section T in the connector 201 bonded onto the first substrate B1 and the heat dissipation member B.

The plug-side heat dissipation plate 400 and the receptacle-side heat dissipation plate 900 are respectively configured to be bondable to the substrate and each include a heat dissipation section (not illustrated) for heat dissipation. The heat dissipation section has an uneven portion having a large number of concaves and convexes formed on its surface, similarly to the shell in the first embodiment. Each of the heat dissipation plates 400 and 900 may be subjected to surface treatment such as plating treatment to have a concave and convex shape formed thereon. As such plating treatment, microfin plating “SUGOHIE” manufactured by EBINAX Co., Ltd., for example, can be used. In order to form the uneven portion, each of the heat dissipation plates 400 and 900 may be pressed to subject its surface to dowel processing.

Each of the heat dissipation plates 400 and 900 preferably has a portion that contacts the housing D, similarly to the shell in the first embodiment. This makes it possible to conduct heat from the housing D to each of the heat dissipation plates 400 and 900 having higher thermal conductivity. At this time, each of the heat dissipation plates 400 and 900 is press-fitted into the housing D, so that the housing D and the heat dissipation plate contact each other at an appropriate pressure, thereby making it possible to conduct heat from the housing D to the heat dissipation plate.

The plug-side heat dissipation plate 400 and the receptacle-side heat dissipation plate 900 have a fitting section E where both the heat dissipation plates 400 and 900 are brought into contact with and fitted into each other. The fitting section E has a smooth portion smoothly formed in a contact portion and is configured such that the area of a contact surface increases. This makes it possible to enhance thermal conductivity. In order to form a smooth shape, the fitting section E may be subjected to surface treatment such as plating treatment for smoothing its surface.

A surface of the contact C is preferably subjected to surface treatment such as plating treatment to have an uneven portion having a large number of concaves and convexes formed thereon, like in the first embodiment.

Then, a mechanism for heat dissipation in the connector device 200 will be described.

On the second substrate B2, heat from the heat generation section H heated by the electronic component A as a heat source is transferred to the heat dissipation plate bonding section T in the receptacle connector 202 along the heat transfer path 100 on the substrate B2, and is transferred to the receptacle-side heat dissipation plate 900. The heat transferred to the receptacle-side heat dissipation plate 900 is dissipated from a heat dissipation section in the receptacle-side heat dissipation plate 900. Heat transferred to a portion other than the receptacle-side heat dissipation plate 900 in the receptacle connector 202 is transferred through a contact portion between the housing D and the receptacle-side heat dissipation plate 900, is dissipated from the heat dissipation section, and is dissipated by convection and radiation in a non-contact portion.

Heat not dissipated by the receptacle connector 202 is transferred from the fitting section E between the receptacle-side heat dissipation plate 900 and the plug-side heat dissipation plate 400 to the counterpart plug-side heat dissipation plate 400, and is dissipated from the heat dissipation section in the receptacle-side heat dissipation plate 400. Heat transferred to a portion other than the plug-side heat dissipation plate 400 in the plug connector 201 is transferred through a contact portion between the housing D and the plug-side heat dissipation plate 400 and is dissipated from the heat dissipation section in the plug-side heat dissipation plate 400, and is dissipated by convection and radiation in a non-contact portion. Heat not dissipated by the plug connector 201 is transferred to the heat dissipation plate bonding section T through the plug-side heat dissipation plate 400, and can be dissipated from the heat dissipation member B provided on the substrate B1 through the heat transfer path 100 on the plug connector 201 side.

Part of the heat from the heat generation section H is also transferred to the contact C having a heat dissipation function, and is dissipated from the surface of the contact C. Heat not dissipated at the contact C in the receptacle connector 202 is transferred through a contact portion between the contact C in the plug connector 201 and the contact C in the receptacle connector 202, and can also be dissipated at the contact C in the plug connector 202.

Thus, heat on the substrate can be dissipated using the heat pass connector according to the present invention.

With the above-described configuration, heat on the substrate can be dissipated from the connector device 200. The above-described heat pass connector according to the present invention can be adopted as various types of connectors.

Hereinafter, a preferred embodiment of the heat pass connector according to the present invention will be described with reference to the drawings.

The plug connector 201 and the receptacle connector 202 in the connector device 200 according to the second embodiment of the present invention are illustrated in FIGS. 15A and 15B. First, a configuration of the plug connector 201 will be described.

The plug connector 201 includes the plug-side heat dissipation plate 400, the plug-side contact 30 arranged outside the plug-side heat dissipation plate 400 when the plug connector 201 is installed on the substrate, and the plug-side housing 20 that houses the plug-side heat dissipation plate 400 and the contact 30. The receptacle connector 202 includes the receptacle-side heat dissipation plate 900, the receptacle-side contact 80 arranged outside the receptacle-side heat dissipation plate 900 when the receptacle connector 202 is installed on the substrate, and the fixed-side housing 60 and the movable-side housing 70 that house the receptacle-side heat dissipation plate 900 and the contact 80.

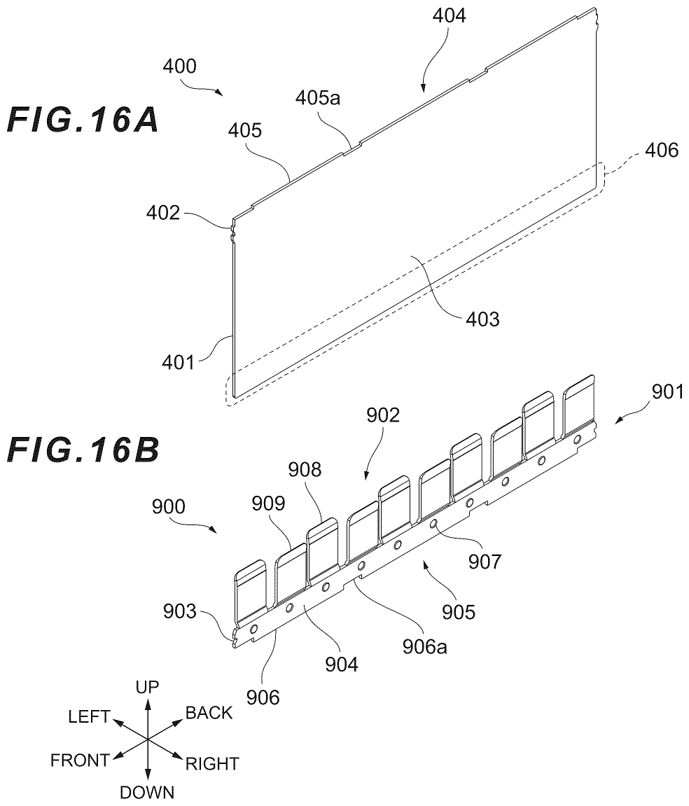

First, a configuration of the plug connector 201 will be described while additionally referring to FIG. 16. The plug-side housing 20 and the contact 30 in the following description are similar to those in the first embodiment, and description thereof is omitted. The plug-side heat dissipation plate 400 is press-fitted in the longitudinal direction of the housing 20 inside the contact 30.

The plug-side heat dissipation plate 400 has a substantially rectangular plate shape to match a shape of the housing 20 such that it can be press-fitted into the plug-side housing 20. The plug-side heat dissipation plate 400 includes a projection-shaped press-fit section 402 that is press-fitted into the housing 20 in part of its surface 401 in the thickness direction (left-right direction), and the press-fit section 402 is press-fitted into and fixed to a press-fit groove 402a formed in the housing 20. The press-fit groove 402a is formed in the housing 20, and may have a configuration in which a protrusion is formed to have a width in which the press-fit section 402 can be press-fitted or a groove-shaped configuration formed to have a width in which the press-fit section 402 can be press-fitted. Further, the plug-side heat dissipation plate 400 includes a surface 403 in the longitudinal direction (front-back direction) of the housing 20 at the time of press-fitting and a mount section 405 on part of a surface 404 as an upper surface in FIG. 16 in the plug-side heat dissipation plate 400 and a bonding surface to the substrate when the plug connector 201 is bonded to the substrate. A lower section 406 in the heat dissipation plate 400 is fitted into the receptacle-side heat dissipation plate 900 in the receptacle connector 202. Such a fitting state will be described below.

The plug-side heat dissipation plate 400 has a heat dissipation function on some of the surfaces including at least the surface 403. For example, the heat dissipation plate 400 is provided with an uneven portion by surface treatment such as plating treatment so that a surface area increases, thereby promoting dissipation of heat to be transferred through the mount section 405.

The mount section 405 serves as the bonding surface to the substrate. The mount section 405 is formed by being provided with a plurality of notch sections 405a to divide the surface 404 in the longitudinal direction (front-back direction). The provision of the notch sections 405a and the mount section 405 makes it possible to disperse a stress received by a soldered portion for deformation of the substrate and to suppress cracking and peeling of solder when the mount section 405 and the plug connector 201 are bonded to the substrate with solder or the like.

Then, a configuration of the receptacle connector 202 will be described while referring to FIG. 15 again. The receptacle-side housings 60 and 70, the contact 80, and the like in the following description are omitted because descriptions thereof overlap those in the first embodiment. The receptacle-side heat dissipation plate 900 is press-fitted in the longitudinal direction (front-back direction) of the housings 60 and 70 inside the contact 80.

The receptacle-side heat dissipation plate 900 includes a main plate 901 having a substantially rectangular shape formed to be press-fittable into the housing 60 and a sandwich plate 902 that sandwiches the plug-side heat dissipation plate 400 at an appropriate pressure in the left-right direction when the plug connector 201 is fitted from above in FIG. 16B.

The main plate 901 has a projection-shaped press-fit section 903 that is press-fitted into the housing 60 on its surface in the thickness direction (left-right direction), and includes a surface 904 in the longitudinal (front-back direction) of the housings 60 and 70 at the time of press-fitting and a mount section 906 as a bonding surface to the substrate when the receptacle connector 202 is bonded to the substrate on part of a lower surface 905 in FIG. 16 of the receptacle-side heat dissipation plate 900.

A configuration, in which some of a plurality of sandwich plates 902, for example, are respectively press-fitted into mounting holes 907 provided on the surface 904 in the main plate 901 and fixed to the main plate 901, for example, is considered. A detailed configuration of the sandwich plate 902 will be described below.

The receptacle-side heat dissipation plate 900 has an uneven portion on at least part of its surface by plating treatment or the like, thereby promoting dissipation of heat transferred from the mount section 906 or the like.

The mount section 906 serves as the bonding surface to the substrate, similarly to the mount section 405. The mount section 906 is formed by being provided with a plurality of notch sections 906a to divide the lower surface 905 in the longitudinal direction (front-back direction).

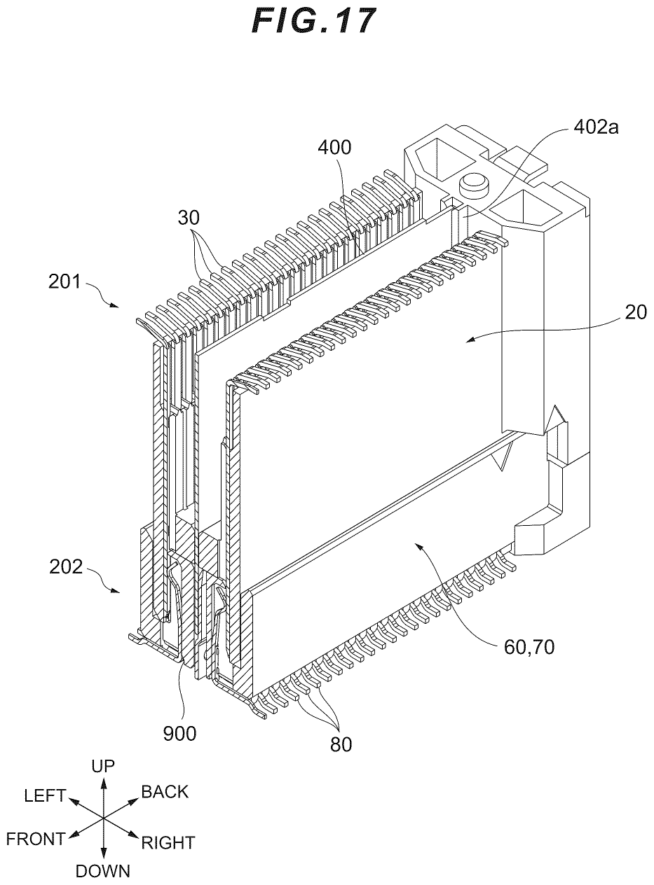

The time of fitting between the connectors 201 and 202, together with a detailed configuration of the sandwich plate 902, will be described while additionally referring to FIGS. 17 to 19. At the time of the fitting between the connector 201 and the connector 202, as both the connectors 201 and 202 are fitted into each other, the lower section 406 in the plug-side heat dissipation plate 400 is sandwiched from the left and right sides by the sandwich plate 902 in the receptacle-side heat dissipation plate 900 so that both the heat dissipation plates 400 and 900 are fitted into each other. In the case, as illustrated in FIG. 16, a configuration in which a left sandwich plate 908 and a right sandwich plate 909, which respectively sandwich the heat dissipation plate 400 from the left side and the right side, are provided side by side alternately on the main plate 901, for example, is considered. Although the sandwich plate 902 may be configured integrally with the main plate 901, the sandwich plate 901 may be more easily manufactured if configured separately from the main plate 901. When the sandwich plate 902 and the main plate 901 are separately configured, part of the sandwich plate 902 is press-fitted into and fixed to the mounting hole 907 provided in the main plate 901, as illustrated in FIG. 16. The sandwich plate 902 is configured to receive the lower section 406 in the heat dissipation plate 400 so that the heat dissipation plate 400 and the sandwich plate 902 contact each other as wide as possible. Various shapes are considered as a shape of the sandwich plate 902. However, the sandwich plate 902 has a substantially rectangular shape and has a shape in which it bends in a bending section 902a slightly toward the outside of the main plate 901 from the press-fitting side of the sandwich plate 902 into the mounting hole 907 and then bends in a bending section 902b to extend upward along the heat dissipation plate 400, the left sandwich plate 908 and the right sandwich plate 909 are formed as a shape bilaterally symmetrical to this shape, and the left sandwich plate 908 and the right sandwich plate 909 are alternately arranged in the longitudinal direction of the main plate 901, thereby making it possible to support the plug-side heat dissipation plate 400 at an appropriate pressure from the left and right sides and to ensure a wide contact surface between the plug-side heat dissipation plate 400 and the receptacle-side heat dissipation plate 900. Further, the sandwich plate 902 has a shape bending slightly outward in a bending section 902c on the other end side of the mounting hole 907, thereby making it easy to introduce and insert a lower end of the plug-side heat dissipation plate 400 and making it possible to support the plug-side heat dissipation plate 400 at an appropriate pressure from the left and right sides and to ensure a wide contact surface between the plug-side heat dissipation plate 400 and the receptacle-side heat dissipation plate 900. This makes it possible to conduct heat transferred from the substrate to the plug-side heat dissipation plate 400 and the receptacle-side heat dissipation plate 900 and dissipate the heat in the uneven portions respectively provided in the heat dissipation plates.

With the foregoing configuration, there can be provided a heat pass connector that efficiently dissipates heat under limited volume conditions by respectively attaching the connectors 201 and 202 to the substrates. In the above embodiment, each of the contacts 30 and 80 may be provided with an uneven portion by plating treatment or the like to promote heat dissipation, like in the first embodiment.

In the above embodiment, heat may be dissipated by a heat dissipation function of each of the contacts 30 and 80 without using the shells 40 and 90 and the heat dissipation plates 400 and 900. In this case, some of the contacts may also be formed as a heat dissipation contact pin dedicated for heat dissipation. Further, a heat transfer path through which heat from the heat generation section H on the substrate is transferred may be connected to a connection portion between the heat dissipation contact pin and the substrate, as described in the first embodiment.

The present invention is not limited to the above embodiments, but can be appropriately improved without departing from the spirit and scope of the present invention. The connector body described in the above embodiments may be a connector having another configuration. A floating connector is not limited either to the configurations in the above embodiments. The floating connector may be adopted as the plug connector.

Although an example in which the mount section in the shell on the receptacle connector side that adopts the floating connector is provided with a large number of notch sections to have a floating function has been described in the above embodiments, a mount section in a shell in a connector that is not a floating connector may be provided with a large number of notch sections to have a floating function.

Although a stack-connected type connector device in which both substrates (first and second substrates) are arranged parallel to each other and electrically connected to each other has been described as an example in the above embodiment, the present invention is not limited to this, but may be applied to a vertically-connected type connector device in which both substrates are arranged perpendicularly to each other and electrically connected to each other, a horizontally-connected type connector device in which both substrates are arranged within the same plane and electrically connected to each other, and the like.

Although the substrate-mounted type connector has been described as an example of a counterpart connector in the above embodiments, the present invention is not limited to this configuration, but various types of connectors such as a cable-mounted type connector are applicable thereto.

What is claimed is:

1. A heat pass connector that is used by being attached to a substrate and is fittable into a counterpart connector, the heat pass connector comprising:
a contact;
a housing that holds the contact; and
a heat pass shell formed of a highly conductive material and surrounding and attached to the housing, wherein
the heat pass shell includes a mount section for bonding the connector to the substrate and a heat dissipation section having a heat dissipation function,
the substrate includes a shell bonding section for bonding the mount section, heat from the heat generation section on the substrate being transferred to the shell bonding section, and
the heat transferred to the shell bonding section is dissipatable by being transferred from the mount section to the heat dissipation section when the heat pass shell is attached to the substrate by bonding the mount section to the shell bonding section.

2. The heat pass connector according to claim 1, wherein the heat dissipation section has an uneven portion formed by subjecting a surface of the heat pass shell to plating treatment and is configured such that a surface area of the heat pass shell increases.

3. The heat pass connector according to claim 1, wherein the heat pass shell has a smooth portion having a smooth surface in a fitting section to be fitted into the counterpart connector and is configured such that a contact area between the heat pass shell and a counterpart shell in the counterpart connector increases.

4. The heat pass connector according to claim 2, wherein the heat pass shell has a smooth portion having a smooth surface in a fitting section to be fitted into the counterpart connector and is configured such that a contact area between the heat pass shell and a counterpart shell in the counterpart connector increases.

5. The heat pass connector according to claim 1, wherein the substrate includes a heat transfer path for transferring the heat from the heat generation section to the shell bonding section, and the heat transfer path is formed by a conductive wiring pattern.

6. The heat pass connector according to claim 1, wherein the mount section includes a conductive foot section that is elastically deformable while remaining bonded to the shell bonding section.

7. The heat pass connector according to claim 6, wherein the foot section has a shape that bends in an L shape outward from the heat pass shell.

8. A heat pass connector that is used by being attached to a substrate and is fittable into a counterpart connector, the heat pass connector comprising:
a heat dissipation plate formed of a highly conductive material;
at least one contact that is arranged outside the heat dissipation plate on the substrate when attached on the substrate; and
a housing that holds the at least one contact and the heat dissipation plate, wherein
the heat dissipation plate includes a mount section for bonding to the substrate and a heat dissipation section having a heat dissipation function,
the substrate includes a heat dissipation plate bonding section for bonding the mount section, heat from a heat generation section on the substrate being transferred to the heat dissipation plate bonding section, and
the heat transferred to the heat dissipation plate bonding section is dissipatable by being transferred from the mount section to the heat dissipation section when the heat dissipation plate is attached to the substrate by bonding the mount section to the heat dissipation plate bonding section.

9. The heat pass connector according to claim 8, wherein the heat dissipation section has an uneven portion formed by subjecting a surface of the heat dissipation plate to plating treatment and is configured such that a surface area of the heat dissipation plate increases.

10. The heat pass connector according to claim 8, wherein the heat dissipation plate has a smooth portion having a smooth surface in a fitting section fitted into the counterpart connector and is configured such that a contact area between the heat dissipation plate and a counterpart heat dissipation plate in the counterpart connector increases.

11. The heat pass connector according to claim 9, wherein the heat dissipation plate has a smooth portion having a smooth surface in a fitting section fitted into the counterpart connector and is configured such that a contact area between the heat dissipation plate and a counterpart heat dissipation plate in the counterpart connector increases.

12. The heat pass connector according to claim 8, wherein the substrate includes a heat transfer path for transferring the heat from the heat generation section to the heat dissipation plate bonding section, and the heat transfer path is formed by a conductive wiring pattern.

13. The heat pass connector according to claim 1, wherein the at least one contact has a heat dissipation function on its surface.

14. The heat pass connector according to claim 13, wherein the at least one contact has an uneven portion formed by subjecting the surface to plating treatment and is configured such that a surface area of the at least one contact increases.

15. The heat pass connector according to claim 13, wherein the substrate includes a heat transfer path for transferring, when each of some of the contacts is attached to the substrate, the heat from the heat generation section to a bonding section between the substrate and the at least one contact, and the heat transfer path is formed by a conductive wiring pattern.

16. The heat pass connector according to claim 8, wherein the at least one contact has a heat dissipation function on its surface.

17. The heat pass connector according to claim 16, wherein the at least one contact has an uneven portion formed by subjecting the surface to plating treatment and is configured such that a surface area of the at least one contact increases.

18. The heat pass connector according to claim 16, wherein the substrate includes a heat transfer path for transferring, when each of some of the contacts is attached to the substrate, the heat from the heat generation section to a bonding section between the substrate and the at least one contact, and the heat transfer path is formed by a conductive wiring pattern.

19. A heat pass connector that is used by being attached to a substrate and is fittable into a counterpart connector, the heat pass connector comprising:
a plurality of contacts; and
a housing that holds each of the plurality of contacts, wherein
the contact has a heat dissipation function on its surface, and
heat transferred to the contact from the substrate is dissipatable by the heat dissipation function.

20. The heat pass connector according to claim 19, wherein the contact has an uneven portion formed by subjecting the surface to plating treatment and is configured such that a surface area of the contact increases.
